(19) United States
(12) Patent Application Publication
(10) Pub. No.: US 2008/0279546 A1
(43) Pub. Date: Nov. 13, 2008

(54) Imaging Device and Mobile Radio Communication Terminal

(76) Inventor: Koji Taniguchi, Kanagawa (JP)

Correspondence Address: DICKINSON WRIGHT PLLC, 1901 L STREET NW, SUITE 800, WASHINGTON, DC, 20036, US

(21) Appl. No.: 11/597,353

(22) PCT Filed: Mar. 7, 2006
(86) PCT No.: PCT/JP2006/004402

§ 371 Date: Sep. 12, 2007

(30) Foreign Application Priority Data
Mar. 22, 2005 (JP) 2005-081672

(51) Int. Cl. G03B 9/02

(52) U.S. Cl. 396/508

(57) ABSTRACT

It is possible to realize a small-size imaging device having light quantity control means such as a shutter unit at a low cost. In the imaging device, an imaging element is mounted on a main part (1a) of a printed circuit board (1) and an imaging signal is introduced from a flexible portion toward outside. A coil (4) as a drive side member of an electromagnetic actuator is connected to the main part (1a) by reflow soldering and the coil (4) is fixed to the main part (1a). After the coil (4) is fixed, a lens unit (2) and a shutter unit (3) having a built-in permanent magnet (3b) as a member driven by the electromagnetic actuator are built on the imaging element.

### TECHNICAL FIELD

The present invention relates to an imaging apparatus and a portable radio communication terminal equipped with that imaging apparatus.

### BACKGROUND ART

Conventionally, in an imaging apparatus, an object is imaged by an image sensor (not shown) mounted on a printed wiring board 11 via a shutter unit 13 and a lens unit 12, as shown in FIG. 1. In this case, the amount of light incident on the image sensor from the object is controlled by shutter unit 13. For this light amount control, an electromagnetic actuator is incorporated in an electromagnetic actuator section 13a of shutter unit 13. The electromagnetic actuator itself is configured with a coil comprising a drive-side member and a permanent magnet comprising a driven-side member forming an integral unit, and energization of the electromagnetic actuator is performed via a flexible printed wiring board 14 provided separately from printed wiring board 11 (see Patent Document 1, for example).
Patent Document 1: Japanese Patent Application Laid-Open No. HEI 9-325381 (FIG. 6)

### DISCLOSURE OF INVENTION

### Problems to be Solved by the Invention

However, when flexible printed wiring board 14 for applying an electrical signal to the electromagnetic actuator is deployed separately from printed wiring board 11 bearing the core part of the imaging apparatus, it is necessary for flexible printed wiring board 14 to be connected to printed wiring board 11, or to be connected to the main wiring board of a mobile phone or the like in which this imaging apparatus is installed. There are consequently problems such as the necessity of securing extra space for such connection, and the necessity of a connector or suchlike member for connection, which make it difficult to achieve small size and low cost for the imaging apparatus.

It is an object of the present invention to provide a small, low-cost imaging apparatus and portable radio communication terminal.

### Means for Solving the Problems

An imaging apparatus of the present invention employs a configuration that includes a printed wiring board that bears and energizes an image sensor or image sensor package, a lens unit, and a light amount control section that controls the amount of light from an object by driving an electromagnetic actuator; wherein a coil section comprising the drive-side member of the electromagnetic actuator is fixedly mounted on the printed wiring board, and a permanent magnet comprising the driven-side member of the electromagnetic actuator is incorporated in the light amount control section.

### ADVANTAGEOUS EFFECT OF THE INVENTION

According to the present invention, a coil section comprising the drive-side member of an electromagnetic actuator is made a separate entity from a permanent magnet comprising the driven-side member, and can be fixedly mounted on a printed wiring board on which an image sensor is mounted, thereby eliminating the necessity of providing a separate flexible printed wiring board or the like for energizing the coil, and enabling a small, low-cost imaging apparatus and portable radio communication terminal to be realized.

### BRIEF DESCRIPTION OF DRAWINGS

FIG. 1 is an oblique drawing showing a conventional imaging apparatus;

FIG. 2 is an oblique drawing of an imaging apparatus according to one embodiment of the present invention;

FIG. 3 is an oblique drawing of an imaging apparatus according to one embodiment of the present invention; and

FIG. 4 is an oblique drawing explaining the coil mounting method of an imaging apparatus according to one embodiment of the present invention.

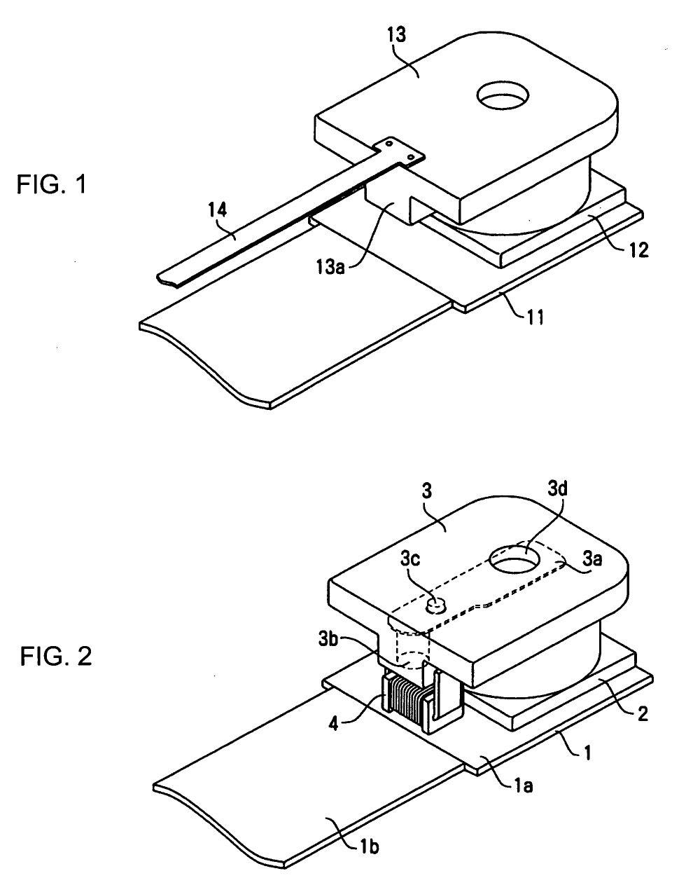

### BEST MODE FOR CARRYING OUT THE INVENTION

An embodiment of the present invention will now be described in detail with reference to the accompanying drawings.

### Embodiment

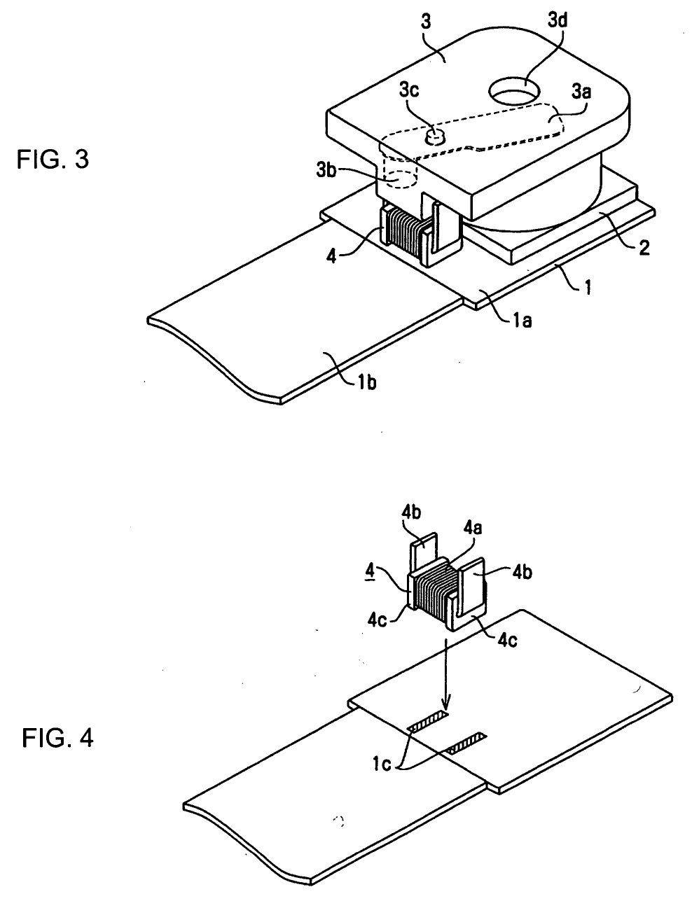

FIG. 2 and FIG. 3 are oblique drawings of an imaging apparatus according to one embodiment of the present invention, with FIG. 2 showing the shutter in the closed state, and FIG. 3 showing the shutter in the open state. FIG. 4 is an oblique drawing explaining the coil mounting method of an imaging apparatus according to one embodiment of the present invention.

In FIG. 2 and FIG. 3, the imaging apparatus has a printed wiring board 1, an image sensor package (not shown) is mounted on a principal part 1a of this printed wiring board 1, and a lens unit 2 and shutter unit 3 are installed thereupon. An object is imaged by the image sensor via shutter unit 3 and lens unit 2, and converted to an electrical signal.

Printed wiring board 1 is a multilayer board fabricated by means of a build-up construction method or the like, and has a highly rigid principal part 1a and a flexibly formed flexible part 1b. On printed wiring board 1, an image sensor such as a CCD element, or an image sensor package in which an image sensor and peripheral electronic parts are packaged, (not shown), is mounted on principal part 1a. An image pickup signal obtained by the image sensor is conducted to the outside via principal part 1a and flexible part 1b.

Upon the image sensor package, lens unit 2 is fixed with the desired installation precision. Lens unit 2 is for optically imaging an object onto the image sensor, and has at least one lens, and at most two or more lenses, of glass or plastic material mounted in a polycarbonate lens-barrel. Therefore, lens unit 2 has low thermal resistance.

Shutter unit 3 for controlling the amount of light is fitted on top of lens unit 2. Shutter unit 3 has an aperture 3d corresponding to an aperture (not shown) of lens unit 2. As shown in FIG. 2 and FIG. 3, a shutter plate 3a and a permanent magnet 3b are incorporated in this shutter unit 3. This permanent magnet 3b forms a part (the driven-side member) of an electromagnetic actuator for driving shutter plate 3a.

As shown in FIG. 2, FIG. 3, and FIG. 4, a coil 4 comprising the drive-side member of the electromagnetic actuator is mounted on principal part 1a of printed wiring board 1. Coil 4 has a winding 4a and yokes 4b. Winding 4a is wound on a bobbin, and the ends of winding 4a are fixed to undersurface parts of bobbin flange parts 4c opposite terminal parts 1c of printed wiring board 1. Coil 4 has high thermal resistance, as do the image sensor and its peripheral electronic parts, and can therefore be mounted directly onto the two terminal parts 1c (lands) provided on printed wiring board 1 by means of reflow soldering or the like.

With this kind of configuration, when winding 4a of coil 4 is energized a magnetic field is generated, and the magnetic field is applied to permanent magnet 3b in a noncontact fashion via yokes 4b. With the application of this field, shutter plate 3a acquires driving force through mutual attraction and repulsion of coil 4 and permanent magnet 3b, and pivots about a shaft 3c. The amount of light passing through aperture 3d is controlled by this pivoting.

Thus, in this embodiment, coil 4, which is the drive-side member of the electromagnetic actuator, is a separate entity from permanent magnet 3b, which is the driven-side member of the electromagnetic actuator. Therefore, coil 4 can be mounted on principal part 1a of printed wiring board 1 by means of a construction method such as reflow soldering at the same time as other electrical parts for which thermal resistance is not a problem, such as the image sensor, for example. When mounted on printed wiring board 1, coil 4 can be energized directly via a print pattern formed on principal part 1a and flexible part 1b thereof, eliminating the necessity of separately providing a flexible printed wiring board for energizing the coil section as in the example of the prior art, and eliminating the need for a superfluous member and superfluous junction space, or superfluous processing.

Thus, coil 4, other electrical parts (not shown) the image sensor package (not shown), and suchlike parts with high thermal resistance among the core electrical parts of the imaging apparatus, are mounted on principal part 1a of printed wiring board 1 by means of reflow soldering. Thereafter, assembly is continued by mounting low-thermal-resistance lens unit 2 and shutter unit 3 sequentially in stacked form.

Lens unit 2 is bonded to the image sensor package or printed wiring board 1 with an ultraviolet-curing type of adhesive that does not require the application of heat. Then shutter unit 3 is positioned on lens unit 2 and fixed in place using a processing method that does not cause any heat damage to lens unit 2 or shutter unit 3, such as screwing or bonding. By this means, shutter unit 3 is installed above the image sensor package.

At this time, assembly is carried out so that permanent magnet 3b of shutter unit 3 is installed with the desired precision at a predetermined position with respect to coil 4 mounted on printed wiring board 1, as shown in FIG. 2 and FIG. 3. Although permanent magnet 3b and coil 4 are separate entities, by establishing a predetermined positional relationship between permanent magnet 3b and coil 4, having the magnetic flux generated when coil 4 is energized conducted to permanent magnet 3b via yokes 4b, and changing the direction of energization of coil 4, permanent magnet 3b can be made to generate thrust in a different direction. Through the movement of permanent magnet 3b between the pair of yokes 4b, shutter plate 3a swivels back and forth about shaft 3c, the degree of opening of aperture 3d is controlled, and the amount of light passing through is controlled.

By using this kind of configuration, in an imaging apparatus according to this embodiment light picked up from an object being imaged passes through aperture 3d of shutter unit 3 and lens unit 2 and forms an image on an image sensor (not shown), and an image pickup signal is obtained. This image pickup signal is conducted to the outside via a print pattern formed on principal part 1a and flexible part 1b of printed wiring board 1.

In an imaging apparatus according to this embodiment, energization of coil 4 is performed by making dual-purpose use of printed wiring board 1, making a superfluous member such as flexible printed wiring board 14 shown in the example of the prior art unnecessary. Also, no mounting restrictions are imposed by low-thermal-resistance members such as lens unit 2, shutter plate 3a, and permanent magnet 3b. Thus, with an imaging apparatus according to this embodiment, the extremely significant effect is obtained of having electrical connection to the shutter unit and so forth essentially completed by means of a reflow soldering process, a process that is essential in many cases from the assembly standpoint. Also, of course, the fact that superfluous connection space and processing are rendered unnecessary enables both space savings and low cost to be achieved at the same time.

As a superfluous member and superfluous construction are rendered unnecessary, reliability is also improved in terms of tolerance of environmental conditions, impact suffered when dropped, and so forth.

A portable radio communication terminal such as a mobile phone equipped with an imaging apparatus according to this embodiment can also be configured. In this case, a small, low-cost portable radio communication terminal can be realized by having coil 4 mounted on the main wiring board of the portable radio communication terminal with the ends of coil winding 4a directly connected thereto.

In this embodiment an example has been illustrated in which the light amount control section is a shutter, but the present invention is not limited to this, and the light amount control section may also be a light-reducing filter, a diaphragm, a light-excluding film, or the like; and furthermore, similar effects can also be obtained if a plurality of light amount control sections and other optical sections are provided.

The present application is based on Japanese Patent Application No. 2005-081672 filed on Mar. 22, 2005, entire content of which is expressly incorporated herein by reference.

### INDUSTRIAL APPLICABILITY

The present invention is useful for implementation of a small, low-cost imaging apparatus. Also, making a mobile phone or the like that incorporates such an imaging apparatus is useful for achieving small size, low cost, and high reliability of a mobile phone or suchlike portable radio communication terminal.

1. An imaging apparatus comprising:
a printed wiring board that bears and energizes an image sensor or image sensor package;
a lens unit; and
a light amount control section that controls an amount of light from an object by driving an electromagnetic actuator, wherein:
a coil section that is a drive-side member of the electromagnetic actuator is fixedly mounted on the printed wiring board; and
a permanent magnet that is a driven-side member of the electromagnetic actuator is incorporated in the light amount control section.

2. The imaging apparatus according to claim 1, wherein, after the coil section is mounted on the printed wiring board, the lens unit is installed on the image sensor and the light amount control section is installed on the lens unit.

3. The imaging apparatus according to claim 1, wherein the image sensor or image sensor package and the coil section are fixed to the printed wiring board by means of reflow soldering.

4. A portable radio communication terminal equipped with the imaging apparatus according to claim 1.
